(19) United States
(12) Patent Application Publication
(10) Pub. No.: US 2008/0017069 A1
(43) Pub. Date: Jan. 24, 2008

(54) WATER VAPOR BARRIER COATING FOR COMPOSITE MATERIALS

(76) Inventor: Longin B. Greszczuk, Mission Viejo, CA (US)

Correspondence Address: INGRASSIA FISHER & LORENZ, P.C. (BOEING), 7150 E. CAMELBACK RD., SUITE 325, SCOTTSDALE, AZ, 85251, US

(21) Appl. No.: 11/867,564

(22) Filed: Oct. 4, 2007

Related U.S. Application Data
(63) Continuation-in-part of application No. 10/816,384, filed on Apr. 1, 2004.
Application No. 10/816,384 is a continuation-in-part of application No. 10/766,702, filed on Jan. 28, 2004.

(51) Int. Cl. C08L 91/06

(52) U.S. Cl. 106/272

(57) ABSTRACT

Embodiments provide composites (and core materials) that are coated with a water vapor barrier coating to reduce water vapor incursion into the composites (and core materials) and to reduce loss of residual moisture content from composite formed during the cure reaction. In an exemplary embodiment, coated composite articles have a composite substrate with a surface that has a water vapor barrier coating. The water vapor barrier-coating reduces water vapor incursion into the coated composite article through the surface when the coated composite is in a hot and humid surrounding environment by at least about 80%. The water vapor barrier coating includes a mixture of waxes and paraffins having a dispersion therein of inorganic powder comprising powdered metal, powdered metal oxide, or powdered metal carbide. The water vapor barrier coating is applied to the surface without solvents and is substantially free of pinhole gaps.

### CROSS REFERENCE TO RELATED APPLICATIONS

This application is a continuation in part of and claims priority from commonly-owned application U.S. Ser. No. 10/816,384 filed Apr. 4, 2004, which is a continuation in part of U.S. Ser. No. 10/766,702, filed Jan. 28, 2004.

### TECHNICAL FIELD

The present embodiments relate to the field of coatings, and more particularly to the coating of composite materials and other polymers prone to gain and/or loss of moisture.

### BACKGROUND

Advanced lightweight structures made with composite materials are becoming increasingly important in a variety of applications, as processes for manufacture improve and as properties of these materials are better understood, and hence more readily customized for particular uses. Composites generally include a solid material (a filler or reinforcement that could be particulate, fibrous, or a woven or non-woven oriented or non-oriented fiber material, etc.) incorporated into a matrix that most typically is an organic polymer. Additives of various kinds may be added to serve a variety of functions. Composites may be fabricated into structural composites that include more than one type of material. For example, a structural composite might include a “sandwich” construction with outer thin layers of a composite covering a core of another material, such as a structured cellular material or a foam or balsa wood. Such lightweight composite materials can be used in a variety of applications, for example, aircraft cabin luggage bins, automobile interior panels, fairings and primary structures of rocket launch vehicles, ship structures, airplane fuselages and wings, and the like. Composites may also be used as monocoque and stiffened structures for applications such as motor cases, nozzles of launch vehicles, underwater structures, high pressure tanks, and like structural components and devices.

In its simplest aspect, engineering the properties of the composite depends upon appropriate selection of the reinforcement material and the matrix material. In a structured product, the structural configuration and core should also be carefully selected for the intended purpose of the product.

Engineered composites are used in the aerospace industry in a variety of structural applications, and are also finding use in other areas, for example the automobile and boat building industries, because they can be made lightweight, strong, and durable. Depending upon the nature of its use, the composite may be subject to harsh environmental conditions of temperature and humidity. Accordingly, it is desirable that the composite resist environmental effects and retain its mechanical properties, or as much of these properties as possible, during its intended lifespan.

### BRIEF SUMMARY

An exemplary embodiment provides a coated composite article that has a composite substrate with a surface that has a water vapor barrier coating. The composite substrate includes a resin matrix with a filler embedded therein. The water vapor barrier-coating reduces water vapor incursion into the coated composite article through the surface when the coated composite is in a hot and humid surrounding environment by at least about 80% as compared to a like uncoated composite article in a like environment. The water vapor barrier coating includes a mixture of waxes and paraffins having a dispersion of inorganic powder comprising powdered metal, powdered metal oxide, or powdered metal carbide throughout the mixture. The water vapor barrier coating is applied to the surface without solvents and is substantially free of pinhole gaps.

Another exemplary embodiment provides a coated composite core material. The composite core material includes a sandwich composite having a core material with a surface that is coated with a water vapor barrier coating. The water vapor barrier coating reduces water vapor incursion through the surface into the core material, when the coated composite is in a hot and humid surrounding environment, by at least about 50% as compared to a like uncoated composite core material in a like hot and humid environment. The water vapor barrier coating includes a mixture of waxes and paraffins having dispersed therein an inorganic powder of powdered metal, powdered metal oxide, or powdered metal. The water vapor barrier coating is applied without solvents and is substantially free of pinhole gaps.

A further exemplary embodiment provides a barrier-coated composite. The barrier-coated composite includes a composite substrate having a resin matrix with a filler embedded therein. The composite substrate also includes a surface to be exposed to a surrounding environment under ordinary conditions of use, and the composite substrate includes therein residual moisture produced by a resin cure reaction during the formation of the composite substrate. The composite substrate has a water vapor barrier coating on at least the surface to be exposed to the surrounding environment. The water vapor barrier-coating reducing loss of the residual moisture from the barrier-coated composite by at least about 80%, as compared to a like uncoated composite in a like surrounding environment. The water vapor barrier coating includes a mixture of waxes and paraffins having a dispersion of an inorganic powder comprising powdered metal, metal oxide, or metal carbide throughout the mixture. The water vapor barrier coating is applied to the surface without solvents and is substantially free of pinhole gaps.

The foregoing represents a brief summary of advantages and features of the embodiments that are detailed in the discussion here below and from which a person of skill in the art will readily appreciate additional benefits and features.

### BRIEF DESCRIPTION OF THE DRAWINGS

Various embodiments will hereinafter be described in conjunction with the following drawing figures, wherein like numerals denote like elements, and

FIG. 1 is a graphical representation of test data comparing the efficacy of an exemplary embodiment in resisting moisture penetration into ROHACELL™ brand foam as compared to a commercial coating and as compared to an uncoated control; and

FIG. 2 is a graphical representation of test data comparing the efficacy of an exemplary embodiment in resisting moisture penetration into fibrous composite as compared to a composite coated with a commercial coating and an uncoated control.

### DETAILED DESCRIPTION

The following detailed description is merely exemplary in nature and is not intended to limit the described embodiments or the application and uses of the described embodiments. Furthermore, there is no intention to be bound by any expressed or implied theory presented in the preceding technical field, background, brief summary or the following detailed description.

Composites usually include filler embedded in or coated with a matrix of an organic polymer or mixtures of polymers. The filler could be selected from powdered filler, fibrous filler, woven filler, non-woven filler, oriented fiber filler, and many other types available commercially. Other additives may be added for a variety of purposes, for example ultra violet inhibitors to retard ultraviolet light induced degradation of the composite matrix, color additives for aesthetic or other reasons, catalysts to facilitate cross linking of the matrix, and other additives for other purposes. The filler and matrix are selected to be compatible with each other and to provide desired physical properties.

Certain polymers used as the matrix material, or as part of the matrix material in combination with other polymers, are known to produce water as a reaction product when the composite is “cured” under ordinary conditions of cure —usually application of heat and pressure. A residual amount of this water is held as moisture within the composite and the matrix material after cure. Non-limiting examples of such composites are the glass/phenolic, graphite/phenolic composites as well as composites made with polyimide polymers and other condensation-type imids.

It has been found that certain composites are prone to cracking after cure. This phenomenon may result in a dramatic adverse effect on mechanical properties. In many cases the cracks appear some period of time after the composite was cured. It has been theorized (without being bound) that, since this phenomenon has been observed in composites that include in the polymeric matrix at least one polymer that produces water upon curing, the cracks may be due to loss of a proportion of any residual moisture that the composite retains internally. In other words, it has been suggested that cracks begin to form in the composite due to “drying out” of the composite through loss of internal residual moisture under conditions of storage or use or both. An example of another type of material that undergoes this behavior is wood.

While not being bound by any theory, it is now believed that those cured composites that include polymers that produce moisture upon cure, have internal moisture equilibrium. This equilibrium is affected by loss of moisture from exposed surfaces into the surroundings. The moisture loss at the surface causes migration of moisture to the surface from within the composite, in an effort to maintain the equilibrium, in accordance with Le Chatelier's principle. At some point, the loss of moisture is of such a magnitude, that the equilibrium cannot be maintained, and this leads to internal stresses within the composite material. The time period for such moisture loss-induced stresses to arise varies based on the type of material, and the environment to which it is exposed. Regardless of time, however, the loss of moisture causes cracking and thereby significantly degrades mechanical properties, often rendering the composite unsuitable for its intended purpose.

In addition, it has been observed that composites and certain sandwich core materials tend to suffer an often dramatic reduction in mechanical properties when they are exposed to hot and humid or wet ambient air conditions. The term “hot and humid ambient conditions” as used herein means conditions ambient air conditions that include temperatures in the range from about 32° F. (about 0° C.) to about 125° F. (about 51° C.) and a relative humidity of from about 30% to about 100%.

The deterioration of mechanical properties has been linked to moisture absorption via water vapor from surroundings. The combined effects of temperature and humidity result in water vapor incursion with a resultant increase in moisture content of the composite material up to an equilibrium moisture content for the particular temperature and humidity conditions, over a period of time. For a sandwich-type material with internal core, water vapor migrates into both the outer composite skin layers and the internal core if it is exposed. If the internal core is not exposed, the amount of water vapor in-migration might result in water vapor migrating to the internal core material from the outer composite layers as a result of moisture equilibration effects. The time period for equilibration of moisture content varies, based on the type of material, the temperature and the relative humidity. Regardless of time, however, the absorption of moisture as water vapor significantly degrades mechanical properties as moisture content increases, and presents a challenge in applications where certain mechanical properties must meet specifications.

In some instances, composite structures are periodically subjected for days to a low humidity environment, and controlled temperatures to “drive out” any absorbed moisture. Removing the moisture may partially restore the mechanical properties, and so the deleterious effects of moisture absorption may be reversible. However, this attempted solution is often not practical and is both costly and time consuming. And, indeed, after the structure is removed from the controlled environment and returned to wet and hot ambient conditions, moisture absorption recommences.

Exemplary embodiments of water vapor barrier-coated composites minimize and/or virtually completely eliminate loss of residual moisture from the composite substrates surfaces covered with the barrier coating composition and also minimize and/or virtually completely eliminate moisture ingress into the composites or underlying core materials. Thus, a composite will maintain its mechanical properties substantially unchanged, despite prolonged exposure to environmental conditions that might otherwise cause loss of residual moisture content, as long as these conditions do not adversely affect the integrity of the coating or result in removal of the coating. For example, exposure to high temperatures might burn the coating, and exposure to inappropriate solvents might remove the coating. In general, when properly applied and maintained, the barrier coating compositions will substantially prevent composite residual moisture loss. Further, the water vapor barrier coating will substantially reduce or eliminate the deleterious effects of moisture absorption into the composite material. When coated directly onto any exposed core material, as might arise when the composite skin is removed or damaged, the water vapor barrier coatings will reduce of eliminate water vapor absorption into the core material.

Thus, in exemplary embodiments, the rate of residual moisture loss, or total moisture loss over a period of time, is reduced to at least about 50% compared to uncoated composites. In some exemplary embodiments, the rate of residual moisture loss or total moisture loss may be by from about 60 to 100% as compared to uncoated composites under the same conditions. Further, in exemplary embodiments, the rate of moisture absorption (as water vapor) or total moisture gain over time is reduced to at least about 50% compared to uncoated composites or uncoated core material. In some exemplary embodiments, the rate of moisture gain or total moisture gain may be by from about 60 to 100% as compared to uncoated composites or uncoated core material under the same conditions.

Exemplary barrier coating compositions include a polymer mixture that includes hydrophobic organic compounds. More particularly, in one non-limiting example, these hydrophobic organic compounds may be esters of fatty acids and aliphatic hydrocarbons. An inorganic powdered additive may also be added.

In one embodiment, the esters of fatty acids include waxes in the range of chain lengths typical of beeswax; and the aliphatic hydrocarbons include paraffins, primarily of carbon chain length C₁₈ to C₃₆, although other carbon chain lengths might also be present in smaller proportion.

In exemplary embodiments, the mixture of waxes and aliphatic hydrocarbons has a melting point in the range from about 120° (49° C.) to about 250° F. (121° C.), and more preferably from about 140° (60° C.) to about 180° F. (82° C.). Preferably, but not necessarily, the mixture is a relatively rigid stable solid at room temperature (about 75° F. (24° C.)).

An embodiment of the polymer mixture may be prepared by combining, in suitable proportions, components A and B, where A is “yellow beeswax” (sold by Freeman Manufacturing & Supply of USA), and B is a “paraffin” (sold by Eastman Kodak of USA). In this embodiment the ratio of A to B may vary from about 90:10 to about 10:90; but preferably about 70:30 to about 30:70 and most preferably, about 60:40.

It has been found that a powdered inorganic material appears to enhance the water vapor barrier properties of the barrier coating. In exemplary embodiments, the inorganic powder is selected from powdered metal or powdered metal oxide. The powdered material should be compatible with the polymers of the mixture, and should have no deleterious side effects. When added into a molten mixture of the polymers, the powdered additive assists in driving out entrapped air or other gasses as the molten mass solidifies, thereby reducing the incidence of occluded air in the composition. The powder also makes the solid more “rigid,” i.e., more stiff with increased hardness. Air or other gas bubbles in the coating will provide gaps for ingress of water vapor and absorption into the composite, or egress of residual moisture content as water vapor from the composite.

It has been found that certain powdered metals and metal oxides enhance the function of air exclusion from the solidified mass during cooling of the molten barrier coating mixture. It is theorized, without being bound, that as the outer surface layer on a mass of the molten coating composition rapidly cools, it applies pressure to internal subsurface molten composition thereby pressure-driving out any included air. The same function is expected if the composition were to be prepared in an environment of gasses other than air, such as inert gas, for example nitrogen. In addition, since metals are electrical conductors, the powdered metal also provides the function of static electrical charge dissipation, thereby preventing the build up of static charge on a composite due to application of the water vapor barrier coating. This added advantage of static charge dissipation is a useful feature in some composite applications.

In exemplary embodiments, the powder is preferably within a size distribution range, which may be dependent upon the nature of the powder. Thus, for example, powdered aluminum, one of the preferred powders, preferably has a size distribution such that the majority of powder particles are in the size range about 25 to about 60 microns. On the other hand, titanium oxide, also a preferred powder, is preferably in the size range of up to about 1 micron. Thus, size per se is not critical, and depends upon the nature of the metal or metal oxide being used.

The quantity of powder to be added depends to some extent upon the nature of the polymer mixture and the type of powder. However, in general, the amount of powder, based upon the total weight of the polymer mixture and the powder, is from about 5 to about 15 wt. %, and most preferably about 10 wt. %.

While the preferred powders are aluminum and titanium oxide, other like metallic and/or ceramic powders might also be expected to function well. Examples include, but are not limited to aluminum oxide, silicon dioxide, zirconium dioxide, titanium carbide, and silicon carbide.

An exemplary method of preparing an embodiment of the water vapor barrier coating composition includes selecting suitable amounts of the fatty acid esters and paraffins for the mixture, and heating the fatty acid-paraffin mixture to its melting point to produce a liquid hydrocarbon mixture. A predetermined amount of powder of a selected type and size distribution may be added to the liquid hydrocarbon mixture, and mixed in while minimizing air entrainment into the liquid mass. In general, the powdered metal or metal oxide or metal carbide should be added in an amount sufficient to permit uniform heating of a mass of the composition, and to provide such internal compression of a mass of the composition upon cooling as to substantially exclude occluded gasses from a cooled mass. After mixing, the powder-containing liquid hydrocarbon mixture is rapidly cooled, for example by placing into a cold freezer or refrigerator preferably at or near about 32° F. (0° C.). During rapid cooling, it is theorized without being bound that the solidification of the outer surfaces of the mixture mass, and its contraction, compresses the interior still-molten portion, and this pressure expels or collapses air bubbles and any entrained air from the interior portion. The solidified mass is then preferably pulverized for ease of subsequent use to coat a substrate, such as a composite structure.

Examples of embodiments of the barrier coatings may be applied by any of a variety of conventional techniques. Typically, once prepared, the barrier coating composition is in solid form and is pulverized or otherwise comminuted to produce particulates of the composition. No solvent is added to the solid composition, whether in particulate form or not, to render it liquid or at least more fluid for ease of application to surfaces. When solvent-based coatings dry, the solvents, which are volatile organic compounds (“VOCs”), evaporate and enter the atmosphere. For this reason, solvent addition is environmentally objectionable and is avoided. Further, even if drying of a solvent-containing coating was carried out in a controlled environment where VOCs were captured, solvent evaporation could produce pinholes in the resulting coating thus impairing the water vapor barrier property. Accordingly, adding solvent is disfavored and application processes are solvent-free.

In general, the composite or composite core material to which the water vapor barrier coating is to be applied should not be heated. Unlike certain other compositions that require heating of the substrate to which a barrier composition is applied in order to permit penetration of the barrier composition into pores or other fissures in the substrate, the water vapor barrier compositions do not require such substrate heating. Indeed, localized heating may be undesirable and may lead to structural damage, from uneven heat-induced expansion effects or other heat-induced effects. Accordingly, while during coating the water vapor barrier composition itself may be heated, heat is not directly applied to the composite or core material being coated.

If the solid (particulate form) water vapor barrier coating composition is applied by heating to a certain degree of softness or to liquefaction, then it may be applied by spraying with a spray gun, brushing onto the surface, applying with rollers or heated rollers, or dip-coating (small parts), or any other conventional means of coating application. To date the only techniques that have been used were to liquefy the coating by heating it to 180° F. and applying it with a brush to a composite or foam component or dip-coating small samples in a liquefied mixture. For large components use of heated rollers and spray guns, modified to keep the mixture liquid, may be more desirable.

Water vapor barrier coating thickness may vary depending upon the nature of the composite substrate, the conditions to which the coated substrate will be exposed, and the particular polymer mixture used in the coating composition. Barrier coating thickness will also vary based on any limitations imposed by the method of coating application. In general, however, a coating thickness of at least about 0.05 mm would be suitable for most applications. It is noted that the coating itself does not change weight (i.e. gain or lose moisture as liquid or as water vapor), which has been verified experimentally.

In solid form, the water vapor barrier coating composition is waxy, and the addition of titanium oxide as a powdered additive cases its color to be white. This permits application of a colored coating to the composite substrate which may be advantageous in certain applications. Of course, other coloring additives may be added as well, if desired. The use of metallic powder, on the other hand, provides a metallic appearance. Thus, aluminum powder results in a composition that has an aluminum metallic sheen.

The water vapor barrier coating composition is chemically stable, eliminates static charge build up (when a conductive powder is used), and is nonreactive with composite substrate materials. Accordingly, it may be applied on a wide range of composite substrate materials, and indeed, on other materials as well to minimize or prevent moisture absorption. The coating may be removed by a variety of means, for example, by dissolving it with suitable chemicals, such as detergents or solvents, or by mechanical scraping off and polishing with a suitable brush or other instrument, or by applying heat to melt the coating and wiping it off, or by a combination of these methods.

Exemplary embodiments of the water vapor barrier coating provide long term protection against loss of residual moisture present in a composite, if the coatings are not subject to processes that damage or remove them. Further, the water vapor barrier coatings also provide a barrier to water vapor from the environment migrating into the composite and thereby adversely affecting physical properties of the composite. The coatings may be repaired if damaged or reapplied, from time to time, as needed to maintain the moisture protection/retention barrier they provide.

### EXAMPLES

### Example 1

Tests were conducted, on a composite core material, to compare the efficacy of exemplary embodiments of water vapor barrier coating compositions with a commercially available coating material that is also intended to prevent moisture absorption, and with a control sample that was not coated.

A total of three specimens of composite core material, ROHACELL™ (trademark of ROHM, GMBH of Germany) foam, were prepared: specimen A was coated with an exemplary embodiment of a water vapor barrier coating; specimen B was coated with CORLAR (a trademark of DuPont Company of Delaware) coating; and specimen C was uncoated. The specimens were identical, except for their coating status, and each measured 2 in.×4 in.×0.5 in. Each specimen was taken from the same sample of ROHACELL foam, and each was dried and weighed to obtain an initial dry weight.

A batch of an exemplary embodiment of a water vapor barrier coating composition was prepared by mixing 60 parts by weight of yellow beeswax with 40 parts by weight of paraffin wax and heating to 180° F. (82° C.) to melt these ingredients. Once the mixture was liquefied, 10 parts by weight powdered aluminum was added. The mixture was then rapidly cooled by placing it in a freezer. The solid composition obtained was pulverized to facilitate use as a coating. A sample of the pulverized mass was heated to liquefaction to allow it to be brushed or “painted” onto specimens.

Specimen A was coated with the exemplary embodiment of the water vapor barrier mixture by brushing a coating of the liquefied mixture onto each exposed surface. Specimen B was coated with CORLAR™. Each of specimens A, B and C were weighed.

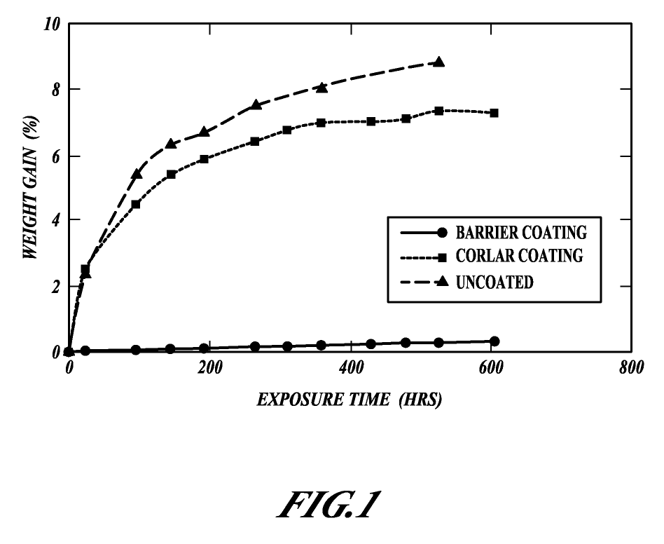

The test specimens were then placed in a chamber maintained at 100° F. (38° C.) and 95% relative humidity. At periodic intervals, the samples were quickly removed, cooled for a few minutes, weighed, and replaced in the chamber. For each sample the weight gain was calculated at each time period as a percentage of the initial weight. The percent weight gain was then determined for each specimen, and plotted against time (since commencement of insertion into the chamber), to yield the curves shown in FIG. 1.

From FIG. 1, it is apparent that the percent weight (moisture) gain of the uncoated and CORLAR™ coated specimen had initially experienced similar weight gain, but after about 100 hours, the uncoated specimen's moisture gain exceeded that of the CORLAR™ coated specimen. At 500 hours, the uncoated specimen had gained about 8.8% moisture, and the CORLAR™ coated specimen had gained about 7.3%. In sharp contrast, the specimen coated with the exemplary embodiment of the water vapor barrier coating had gained about 0.2% moisture. This represents a significant decrease of about 97.7% in moisture gain relative to the uncoated specimen, and about 97.3% relative to the CORLAR™ coated specimen.

### Example 2

A similar test to that of Example 1 above was conducted to determine the efficacy of the coating composition in preventing moisture absorption into a graphite/epoxy outer layer taken from a sandwich composite structure, as compared to CORLAR™ coating or no coating at all.

Again, three specimens were prepared this time each selected from the graphite epoxy composite layer, and each of identical size. One specimen was coated with an exemplary embodiment of the present water vapor barrier coating, in Example 1 above and another with CORLAR™. The last was not coated.

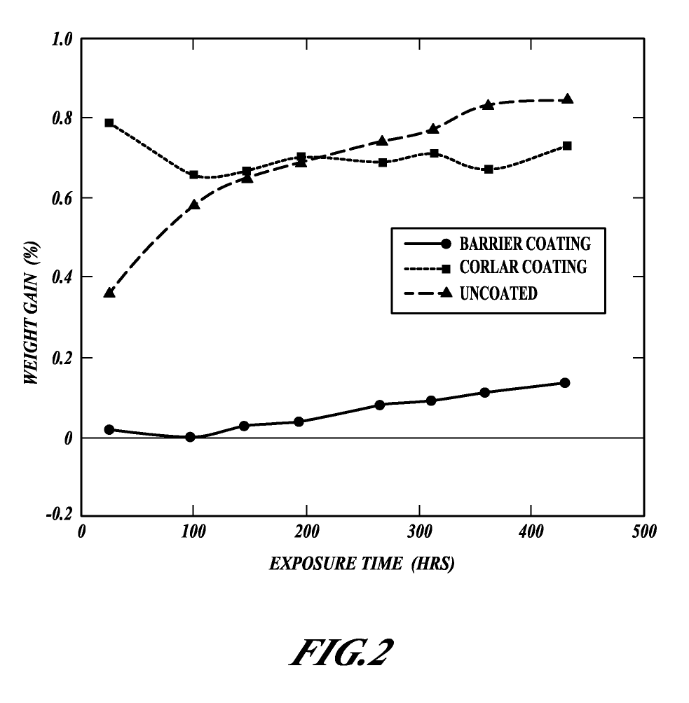

Following the procedure of Example 1, weight gain of each specimen in the chamber was determined at preset intervals. The moisture gain was calculated as a percentage and plotted against time for each specimen to obtain the graph of FIG. 2.

After about 400 hours, the uncoated control specimen had gained over 0.84% moisture, while the CORLAR™ coated specimen had gained 0.7%. In contrast, the specimen having the exemplary embodiment of the water vapor barrier coating only gained about 0.12%.

From these tests, it can be concluded that the exemplary embodiment of the water vapor barrier reduces moisture absorption by the epoxy/graphite composite by about 85% relative to an uncoated composite and 83% relative to a CORLAR™ coated composite.

### Example 3

A similar test to that of Examples 1 and 2 was conducted to determine the efficacy of the coating composition in preventing moisture loss (moisture that is given off during cure reactions) in graphite/phenolic composite samples subjected to accelerated aging. Here again samples were coated with the above noted coating and with commercial coatings including Polysulfone Elastomer Coating PR1422 made by Products Research and EA956 Epoxy coating made by Hysol Corporation which now is marketed by Henkel Company. One specimen, control, contained no coating.

Again, four specimens of identical size (0.25 in. by 0.25 in. by 0.25 in.) were prepared. One specimen was coated with an exemplary embodiment of the present water barrier coating; one specimen was coated with Polysulfone Elastomer; one specimen was coated with Hysol 956. The fourth specimen was uncoated.

The moisture loss versus time was determined using Thermo Gravimetric Analysis (TGA) whereby the specimens were exposed to elevated temperatures and weight measurements were made at preset time intervals. The moisture loss was calculated as a percentage and plotted against time for each specimen.

As it was not intended to high temperature applications the first specimen coated with an exemplary embodiment of the present water barrier coating was exposed to 120° F. whereas the other three were exposed to 160° F.

After about 4,000 minutes (67 hrs) the uncoated specimen lost 2.4% moisture while the specimens coated with EA956 Epoxy and Polysulfide Elastomer lost 2.3% and 1.4% respectively. In contrast, the specimen having the exemplary embodiment of the water vapor barrier coating lost only approximately 0.15%.

From these tests it can be concluded that the exemplary embodiment of the water barrier reduces moisture loss of graphite/phenolic composite by about 94% compared to an uncoated composite and by about 89% to 93% compared to more conventional coatings.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. A coated composite article comprising:
a composite substrate comprising a resin matrix having a filler embedded therein, the composite substrate comprising a surface; and
a water vapor barrier coating the surface, the water vapor barrier-coating reducing water vapor incursion into the coated composite article through the surface when the coated composite is in a hot and humid surrounding environment by at least about 80% as compared to a like uncoated composite article in a like environment, the water vapor barrier coating comprising a mixture comprising waxes and paraffins having therein a dispersion of inorganic powder comprising powdered metal, powdered metal oxide, or powdered metal carbide throughout the mixture, the water vapor barrier coating applied to the surface without solvents and substantially free of pinhole gaps.

2. The coated composite of claim 1, wherein the coated composite article comprises: graphite/phenolic nozzles of launch vehicles; interstages and other primary structures of launch vehicles utilizing monocoque and sandwich construction; composite structures of aircraft, marine structures made of composites, composite pressure vessels and numerous other applications utilizing composites, and in particular sandwich construction.

3. The coated composite of claim 2, wherein the paraffins comprise primarily aliphatic hydrocarbons having chain lengths in a range from about 18 to about 36 carbon atoms.

4. The coated composite of claim 1, wherein the inorganic powder comprises aluminum, titanium oxide or aluminum oxide.

5. The coated composite of claim 1, wherein the inorganic powder comprises aluminum powder in a size range from about 25 to about 60 microns.

6. The coated composite of claim 3, wherein the inorganic powder comprises aluminum powder in a size range from about 25 to about 60 microns.

7. The coated composite of claim 1, wherein the mixture is a solid at temperatures in a range below about 140° F., and liquefies upon heating to a temperature in a range from about 170 to about 190° F.

8. The coated composite of claim 1, wherein the mixture comprises an amount of inorganic powder in a range from about 5 wt. % to about 15 wt. %, based on weight of the mixture.

9. The coated composite of claim 1, wherein the water vapor barrier coating reduces water vapor absorption by from about 60 to about 100% as compared to a like uncoated composite.

10. A coated composite core material comprising:
a sandwich composite comprising a core material, the core material comprising a surface; and
a water vapor barrier coating the surface of the core, the water vapor barrier coating reducing water vapor incursion through the surface into the core material, when the coated composite is in a hot and humid surrounding environment, by at least about 80% as compared to a like uncoated composite core material in a like hot and humid environment, the water vapor barrier coating comprising a mixture comprising waxes and paraffins having dispersed therein an inorganic powder comprising powdered metal, powdered metal oxide, or powdered metal, the water vapor barrier coating applied without solvents and substantially free of pinhole gaps.

11. The coated composite core material of claim 10, wherein the paraffins comprise primarily aliphatic hydrocarbons having chain lengths in a range from about 18 to about 36 carbon atoms.

12. The coated composite core material of claim 10, wherein the core material comprises a cellular core material or a foam core material.

13. A barrier-coated composite, the barrier-coated composite comprising:
a composite substrate comprising a resin matrix having a filler embedded therein, the composite substrate comprising a surface to be exposed to a surrounding environment under ordinary conditions of use, the composite substrate comprising residual moisture produced by a resin cure reaction in formation of the composite substrate; and
a water vapor barrier coating on at least the surface exposed to the surrounding environment, the water vapor barrier-coating reducing loss of the residual moisture from the barrier-coated composite by at least about 80%, as compared to a like uncoated composite in a like surrounding environment, the water vapor barrier coating comprising a mixture comprising waxes and paraffins having a dispersion of an inorganic powder comprising powdered metal, metal oxide, or metal carbide throughout the mixture, the water vapor barrier coating applied to the surface without solvents and substantially free of pinhole gaps.

14. The barrier-coated composite of claim 13, wherein the mixture comprises beeswax and paraffins.

15. The barrier-coated composite of claim 13, wherein the paraffins comprise primarily aliphatic hydrocarbons having chain lengths in a range from about 18 to about 36 carbon atoms.

16. The barrier-coated composite of claim 13, wherein the inorganic powder comprises aluminum powder comprising particulates in a size range from about 25 to about 60 microns.

17. The barrier-coated composite of claim 13, wherein the inorganic powder comprises titanium oxide, aluminum oxide or aluminum.

18. The barrier-coated composite of claim 13, wherein the mixture is a solid at temperatures in a range below about 120° F., and liquefies upon heating to a temperature in a range from about 140° to about 180° F.

19. The barrier-coated composite of claim 13, wherein residual moisture loss from the barrier coated composite is reduced by from about 60 to about 100% as compared to a residual moisture loss from a like uncoated composite.

20. The barrier-coated composite of claim 13, wherein the mixture is a solid at temperatures in a range below about 140° F., and liquefies upon heating to a temperature in a range from about 170 to about 190° F.
